(19) United States
(12) Patent Application Publication
(10) Pub. No.: US 2009/0135373 A1
(43) Pub. Date: May 28, 2009

(54) Variable-speed text projector

(76) Inventor: Gary Dreiblatt, New York, NY (US)

Correspondence Address: Gary Dreiblatt, Apartment #9B, 501 West 110th Street, New York, NY, 10025, US

(21) Appl. No.: 11/986,587

(22) Filed: Nov. 23, 2007

(51) Int. Cl. G03B 21/10

(52) U.S. Cl. 353/4

(57) ABSTRACT

This invention introduces a variable-speed text projector that consists of two concentric cylinders and uses the convection of heat from a central light bulb to rotate the inner cylinder. A circular cover that fits onto the larger outer cylinder (projection screen). This circular cover controls the speed of the rotation of the inner cylinder. By venting the heat emitted by the bulb (controlling heat flow) in small to large increments, the cover adjusts the speed of the moving text. This constructed top is necessary to this device. The preferred embodiment provides an ease of facility and control of speed to the user who desires to read the text in comfort.

### FIELD OF INVENTION

The present invention relates generally to text projection, and more specifically to a mechanical means to control the speed of the rotating text projector by venting different amounts of thermal convection from a bulb source.

### BACKGROUND OF INVENTION

Spinning or rotating lamps were a centuries-old art form from Asia that utilized a non-electrical form of heat (candle or oil lamp) to turn a cylinder decorated with artistic images. This art form has been copied and popularized in the contemporary toy market with decorative images portraying sports, nature, fairy tales, etc. These images are projected with a small light bulb through a cylinder onto a square outer screen usually made of plastic or paper. Although this embodiment rarely if ever uses text, the square or rectangular outer screen would distort the text significantly by the varying distance between the text and screen. This necessitates the preferred embodiment of a cylindrical outer screen that maintains a constant distance and ensures a sharp text image.

Most importantly, the inner cylinder turns very quickly due to the low frictional coefficient of the materials used at the apex of the cylinder and the light paper construction of the cylinder itself. For ease of reading, the user must be able to vary the speed of the inner cylinder, which in turn controls the flow of the text. Thus, there is a critical need for a projector of variable speed.

### SUMMARY OF INVENTION

The present invention is a projector including a light source, an inner cylinder with the inner cylinder including a lower part with cut-out images and an upper part and the upper part having vanes folded in the same direction to cause the inner cylinder to rotate. The projector also includes an outer cylinder surrounding the inner cylinder with the outer cylinder comprised of translucent material and a cover, which fits together with the outer cylinder to control the rotation of the inner cylinder. The cover controls the flow of heated air rising from the light source, thereby controlling the speed of the inner cylinder. The inner and outer cylinders are equidistant at all points, thereby causing the cut-out images to be clear and focused on the outer screen. The cover is removable to provide access to the inner cylinder in order to replace the inner cylinder and change the text.

The cover has symmetrical openings on two layers that indicate the general rate of rotation to the user and the cover constantly vents heat to prevent heat buildup and to prevent the inner cylinder from stopping.

The present text projector creates a need that the prior art does not address. The specific invention of a reliable variable speed cover improves the projector enormously by making it usable to a broad number of readers. This cover efficiently controls the constant heat flow from the bulb without interrupting or disturbing any other part of the mechanism. The user may control the speed of the text (cylinder) to his or her desired comfort level.

This invention introduces a variable-speed text projector that consists of two concentric cylinders and uses the convection of heat from a central light bulb to rotate the inner cylinder. A circular cover that fits onto the larger outer cylinder (projection screen). This circular cover controls the speed of the rotation of the inner cylinder. By venting the heat emitted by the bulb (controlling heat flow) in small to large increments, the cover adjusts the speed of the moving text. This constructed top is necessary to this device. The preferred embodiment provides an ease of facility and control of speed to the user who desires to read the text in comfort.

The present invention is essential to a text projector of this type. The low wattage bulb supplies a constant flow of heat that turns the inner cylinder at a fairly uniform and rapid speed. The cover of the present invention regulates this convection while the delicate balance and surfaces of the materials remain uninterrupted.

This cover can be adjusted with one or two hands and will vent or capture thermal convection from the bulb to speed or slow the rotation of the inner cylinder. The cover or top is capable of providing a wide range of speeds and the mechanism responds quickly to any changes of heat flow. Furthermore, it is necessary to remove and then replace the cover to change the inner cylinders and introduce new text. The preferred embodiment is designed for this purpose and well suited to frequent changes. The cover is easily removed and when returned to position fits snugly enough to contain the heat and maintain the balance of the cylinders.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

FIG. 1 is a perspective view of the inner cylinder located inside the outer cylinder in accordance with the preferred embodiment of the present invention.

FIG. 2 is a perspective view of the inner cylinder in accordance with the preferred embodiment of the present invention.

FIG. 3 is a top view of the upper portion of the inner cylinder in accordance with the preferred embodiment of the present invention.

FIG. 4a is a top view of the top portion of the cover in a fully open position in accordance with the preferred embodiment of the present invention.

FIG. 4b is a top view of the top portion of the cover in a partially open position in accordance with the preferred embodiment of the present invention.

FIG. 4c is a top view of the top portion of the cover in a closed position in accordance with the preferred embodiment of the present invention.

FIG. 4d is a top view of the bottom portion of the cover in accordance with the preferred embodiment of the present invention.

### DETAILED DESCRIPTION

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific functional details disclosed herein are merely representative, yet in that regard, they are deemed to afford the best embodiment for purposes of disclosure and to provide a basis for the claims herein which define the scope of the present invention.

Moreover, well known methods and procedures for both carrying out the objectives of the present invention and illustrating the preferred embodiment are incorporated herein but have not been described in detail as not to unnecessarily obscure novel aspects of the present invention.

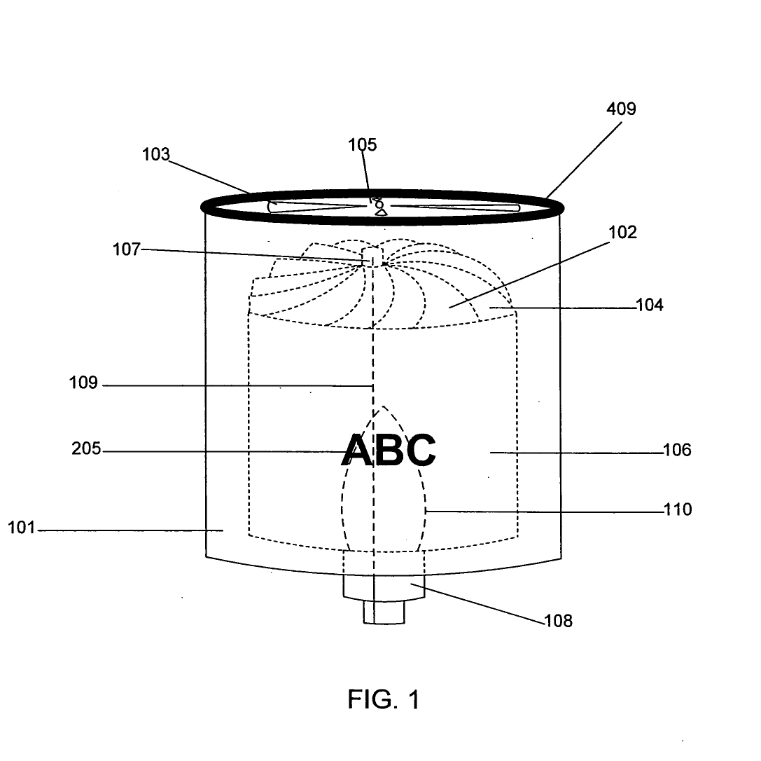

Referring to FIG. 1, which illustrates an inner cylinder 106 with image cut-out 205 that preferably consists of text/images. The inner cylinder 106 is mounted and balanced above a lamp base 108 on a metal wire 109 (male) penetrating a glass apex 107 (female). The wire and glass union provides an exceptional low friction connection that allows for easy rotation and sensitivity to heat fluctuation. The outer cylinder 101 is made of translucent paper and receives the image cut-out 205 of the inner cylinder 106. The distance between the inner and outer cylinders is constant so as to prevent distortion of the text/images. The lamp base 108 houses a low wattage bulb 110 that provides a constant source of heat to rotate the inner cylinder 106. The vane 102 and space 104 arrangement is constructed from heavy stock paper and captures and deflects the heat from the bulb generating sufficient torque to rotate the inner cylinder 106.

The cover 105 sits on the top of the outer cylinder 101 with the annular lip 409 securing its position. The openings 103 are four sectors symmetrically arranged and can be opened or closed to vent or capture heat from the bulb 110. This cover is new to the art and provides a reliable and consistent method for controlling rotation of the inner cylinder 106 and hence the speed of the text.

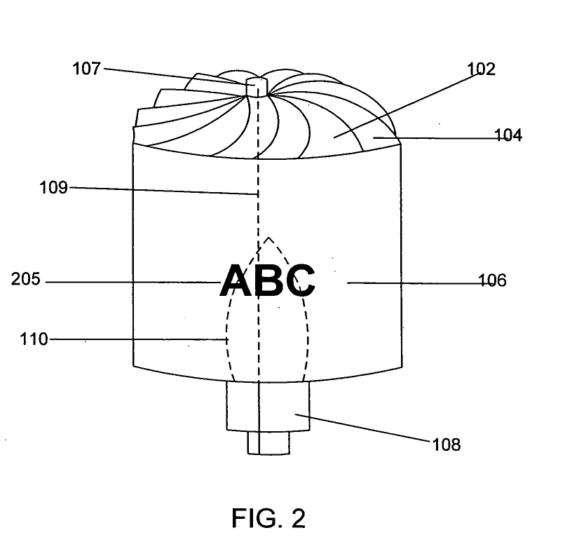

FIG. 2 shows the inner cylinder 106 made of lightweight opaque paper so that light is effectively projected through the sample image cut-out 205. Lamp Base 108 uses a low wattage bulb 110 to project light through the image cut-out 205. Bulb 110 generates heat that rises and is deflected by vane(s) 102 through space(s) 104. This produces a torque to rotate the inner cylinder 106 around the preferably metal wire 109, which serves as the central axis. Metal wire 109 rises from the lamp base 108 and avoids the bulb 110 with preferably two right angle bends. The metal wire 109 terminates in the glass apex 107. The minimal friction of the glass resting on the wire provides little resistance to rotation. This embodiment is commonly seen in the previously mentioned spinning or rotating lamps that one sees today.

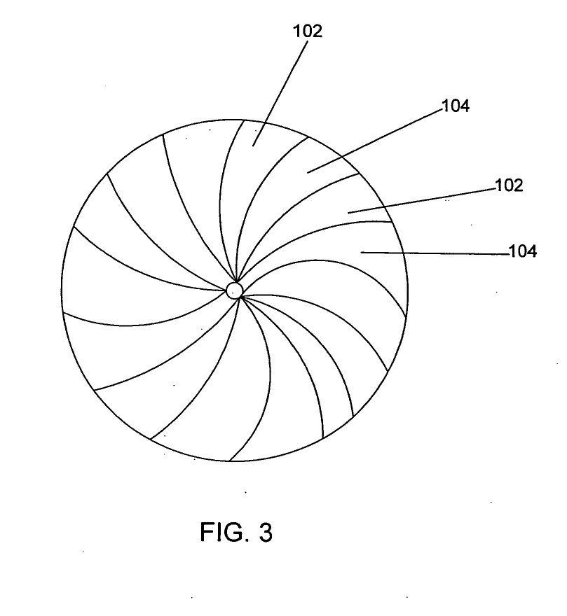

FIG. 3 illustrates the consecutive arrangement of vane(s) 102 and space(s) 104 that capture and redirect heat from the bulb. Although there are twelve vanes and twelve spaces, the mechanism is not limited to the present embodiment.

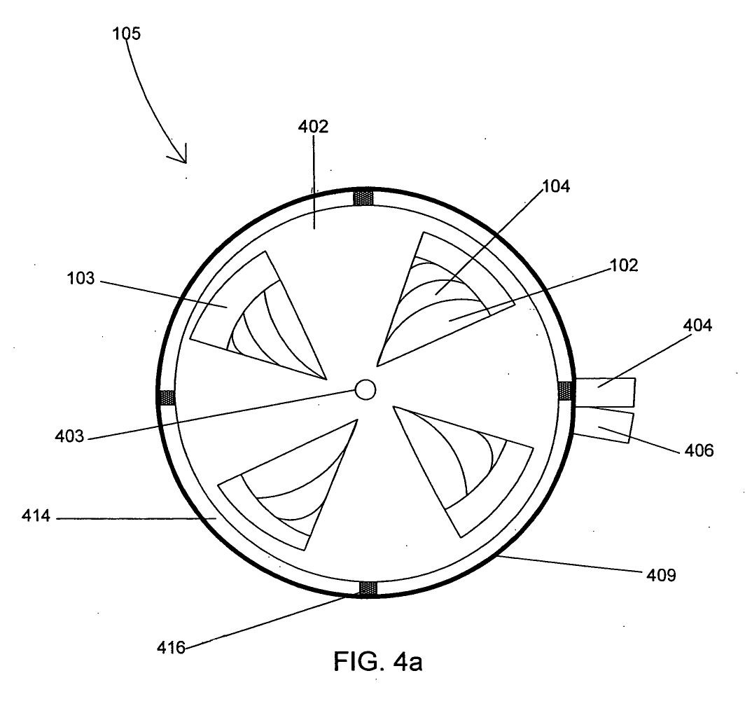

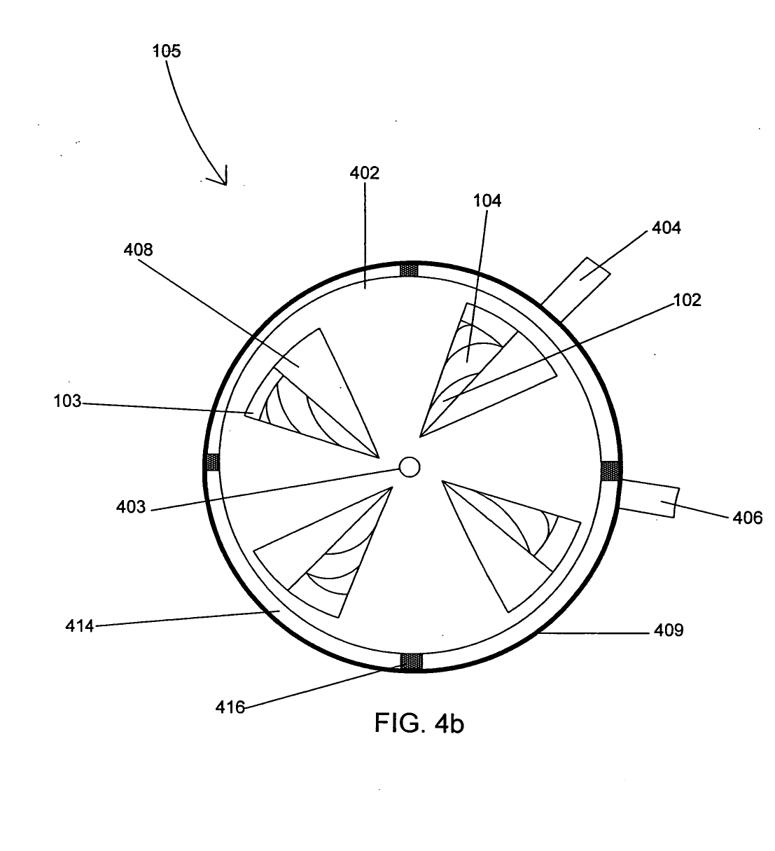

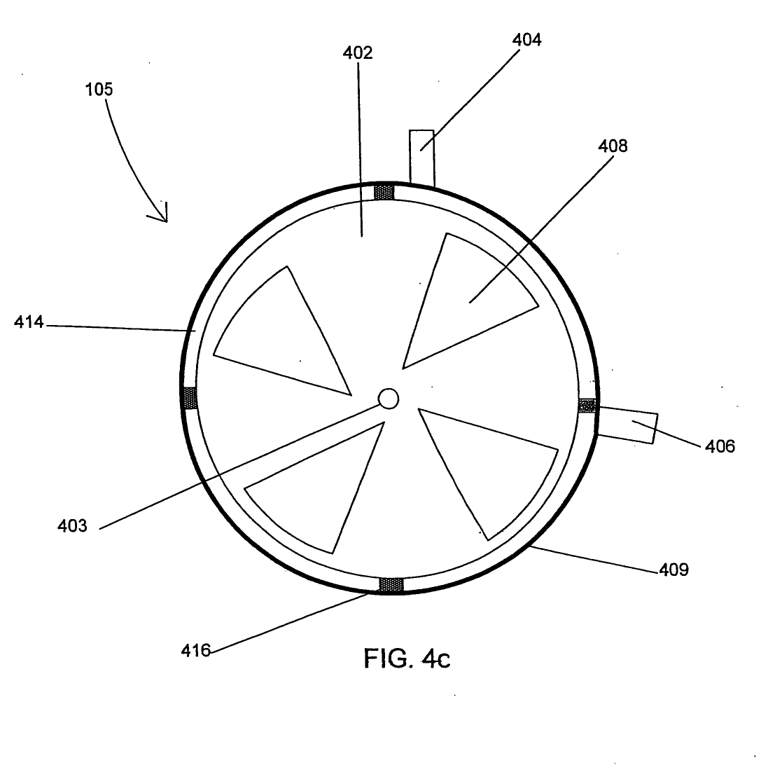

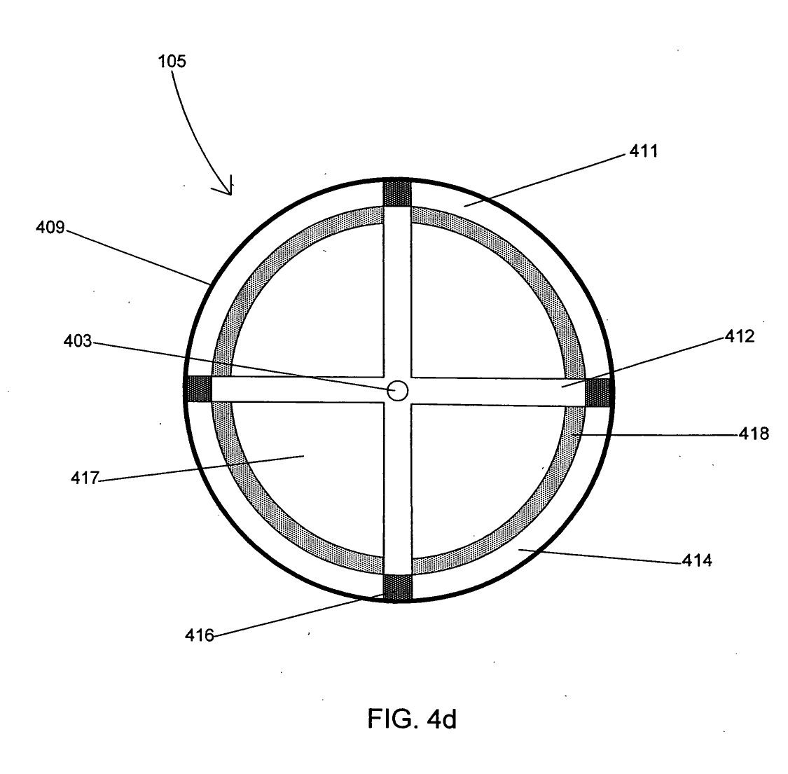

FIG. 4a illustrates the top portion of the cover 402, which consists of preferably four equal openings 103 that are symmetrically arranged around the pivot 403. The pivot 403 is a finely bent unshaped wire that connects all three layers of the cover 105 through a central hole. The pivot 403 acts as an axle so that the top and middle layers of the cover can rotate smoothly. The existence of the pivot 403 is critical in maintaining the delicate balance of the entire mechanism.

In FIG. 4a, the four equal openings 103 are open to their maximum extent as seen in this figure. They can be easily and finely adjusted by moving one or both of the top tab 404 and middle tab 406 relative to the central longitudinal axis as defined by the pivot 403. These tabs connect to the top and middle cover layers of identical circumference, which lay one on the other.

The openings 103 as viewed allow for the maximum rotational speed of the inner cylinder 106. In the preferred embodiment the speed of the rotation of the inner cylinder 106 and hence the text are at their fastest because the venting of the heat from the bulb is maximized. The space(s) 104 and vane(s) 102 located at the top of the inner cylinder 106 are visible through the openings 103.

Attention should be paid to the annular open space 414. This unique feature is not obvious to those skilled in the art. It provides a way for heat from the bulb to escape and is essential to the structure of the cover and the purpose of the invention. The annular open space 414 ensures both that the mechanism does not get too hot, an obvious safety issue, and that the inner cylinder 106 does not stop.

FIG. 4b shows the top portion of cover 402 with four equal openings 103 as well as the middle portion of cover 408. Furthermore, the top, portion of cover 402 and the middle portion of cover 408 contain preferably four identical openings 103. Additionally, the positions of the top tab 404 and the middle tab 406 indicate that the openings 103 are half closed. The decrease in the open area substantially slows the venting of heat and hence the rotation of the inner cylinder 106. The space(s) 104 and vane(s) 102 are less visible through the openings 103.

FIG. 4c shows the top portion of cover 402 with four equal openings 103. The positions of the top tab 404 and the middle tab 406 indicate that the openings 103 are closed. This causes the inner cylinder 106 and hence the text to move at their slowest rate. Heat from the bulb 110 is allowed to escape through the annular open space 414 preventing the inner cylinder 106 from stopping. The space(s) 104 and vane(s) 102 are not visible.

It should be made clear that while three different top tab 404 and middle tab 406 arrangements and openings 103 are viewed in FIGS. 4a-c, there are innumerable size offerings that allow the user to find the speed that most suits him or her. This is a significant improvement from the previous art that tends to rotate at one fast speed.

FIG. 4d shows the bottom portion of cover 411. The cross supports 412 and circular support 418 are attached to the annular lip 409 through the support tabs 416. This design provides a secure foundation for the top and middle layers of the top portion of cover 402 and is a base for the pivot 403. In the preferred embodiment, the inner open space 417 minimizes friction with the middle layer of the top portion of cover 402. The annular open space 414 vents heat from the bulb whether or not the openings 103 are open or closed. The annular lip 409 has a slightly larger circumference to fit easily over the outer cylinder 101. This allows the cover 105 to be removed, thus permitting the user to change the inner cylinder 106 and consequently the image/text to be displayed.

In operation, the bulb 110 is turned on by a user. The convection of heat created by the illuminated bulb flows from the bulb 110 to the vane(s) 102 located on top of the inner cylinder 106, thus commencing the rotation of the inner cylinder 106. As the inner cylinder. 106 begins to spin, the cut-out images on the inner cylinder 106 are now being displayed through the outer cylinder 101 and onto the surface of the user's choice for all to enjoy. As the inner cylinder 106 rotates, the user is capable of varying the speed of the inner cylinder 106 by sliding the top tab 404 and the middle tab 406 of the cover 105. By varying the speed of the inner cylinder 106, the user is varying the speed by which the images or text are projected on a surface.

To sum up, while spinning or rotating light devices have been used since well before the age of electricity, the use of a mechanism of this type for text projection created a need to control the speed of the rotation. This cover meets that need in a reliable and consistent way through controlling the flow of heat from a constant source. People who use this projector, readers of text from the simple to the complex, can now fully enjoy the elegant and aesthetic qualities of this device.

Although specific embodiments of this invention have been clearly depicted and described, it should be understood that the materials might be reconfigured. In no way should this deflect from or undermine the spirit of the invention as set out in this document or undermine the principles as claimed.

While the present invention has been described with reference to the preferred embodiment and alternative embodiments, which have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1) A projector, comprising:
a light source;
an inner cylinder, said inner cylinder including a lower part with cut-out images and an upper part, said upper part having vanes folded in the same direction to cause said inner cylinder to rotate;
an outer cylinder surrounding said inner cylinder, said outer cylinder comprised of translucent material; and
a cover which fits together with said outer cylinder to control the rotation of said inner cylinder.

2) The projector of claim 1 wherein said cover controls the flow of heated air rising from said light source, thereby controlling the speed of said inner cylinder.

3) The projector of claim 1 wherein said cut-out images are displayed on an outer screen.

4) The projector of claim 1 wherein said inner and outer cylinders are equidistant at all points, thereby causing said cut-out images to be clear and focused.

5) The projector of claim 1 wherein said cover is removable to provide access to said inner cylinder in order to replace said inner cylinder and change text.

6) The projector of claim 1 wherein said cover controls the rate of convection of heat through said vanes.

7) The projector of claim 1 wherein said cover has symmetrical openings on two layers that indicate the general rate of rotation to the user.

8) The projector of claim 1 wherein said cover constantly vents heat to prevent heat buildup and said inner cylinder from stopping.

9) A method for projecting comprising the steps of:
utilizing heat from a light source;
passing the heat through vanes, causing an inner cylinder containing cut-out images to spin;
passing the heat through openings of a cover;
projecting the light source through the cut-out images onto a,translucent outer cylinder.

10) The method of claim 9, further comprising the step of controlling the flow of heat from the light source, thereby controlling the speed of the inner cylinder.

11) The method of claim 9, further comprising the step of displaying images on the outer cylinder.

12) The method of claim 9, wherein the inner and outer cylinders are equidistant at all points, thereby causing the cut-out images to be clear and focused.

13) The method of claim 9, wherein the cover is removable to provide access to the inner cylinder in order to replace the inner cylinder and change the cut-out images.

14) The method of claim 9, further comprising the step of controlling the rate of convection of heat through the vanes.

15) The method of claim 9, wherein the cover has symmetrical openings on two layers that indicate the general rate of rotation to the user.

16) The method of claim 9, wherein the step of passing the heat through the openings of the cover vents the heat to prevent heat buildup and to prevent the inner cylinder from stopping.
